(19) United States
(12) Patent Application Publication
(10) Pub. No.: US 2004/0177658 A1
(43) Pub. Date: Sep. 16, 2004

(54) LAPTOP SECURITY DEVICE

(75) Inventor: Terry L. Mitchell, Grand Rapids, MI (US)

Correspondence Address: MCGARRY BAIR PC, 171 MONROE AVENUE, N.W., SUITE 600, GRAND RAPIDS, MI, 49503, US

(73) Assignee: ALPHAQUEST LLC, Rockford, MI (US)

(21) Appl. No.: 10/707,531

(22) Filed: Dec. 19, 2003

Related U.S. Application Data
(60) Provisional application No. 60/319,800, filed on Dec. 19, 2002.

(51) Int. Cl. E05B 73/00

(52) U.S. Cl. 70/58

(57) ABSTRACT

A lockable enclosure for securing a laptop computer against unauthorized removal comprises a housing having a spring-assisted pivotable cover which automatically locks when closed. The housing accommodates a docking station, and is provided with apertures for routing wiring and cables from the computer to exterior power, data, and communication ports. One embodiment of the lockable enclosure is adapted to be integrally mounted to a worksurface such as for integrated use with a portable laptop computer worktable. Another embodiment of the lockable enclosure is adapted for mounting to the rear of a workspace surface and comprises a movable laptop computer support pan for extending the laptop computer to the front of the workspace surface.

### CROSS REFERENCE TO RELATED APPLICATIONS

This application claims the benefit of U.S. provisional application Serial No. 60/319,800, filed Dec. 19, 2002, which is incorporated herein in its entirety.

### BACKGROUND OF INVENTION

1. Field of the Invention

The invention relates to security devices for computers. In one aspect, the invention relates to a lockable enclosure for securing a laptop computer against theft. In another aspect, the invention relates to a lockable enclosure for securing a laptop computer to a work area.

2. Description of the Related Art

Laptop computers are increasingly becoming the personal computer of choice for business use. It is estimated that over 33 million laptop computers were sold in 2001, and that by 2003, laptop computer sales will exceed sales of desktop personal computers. The insurance industry has estimated that 319,000 laptop computers were stolen in 1999. While the theft of the computer imposes a substantial cost in time and replacement, the loss of confidential data is a much more serious problem. However, few satisfactory solutions to the problem of laptop theft have been developed.

Businesses have responded to laptop theft by implementing security policies that require employees to always do one of the following: ensure that the computer is secured to the work station with a heavy cable, lock the laptop in a drawer, or keep the computer with the employee when the employee leaves the work station, particularly at the end of the day. These alternatives are not always convenient or practical. Thus, the computer is not always adequately secured 100 percent of the time.

One common security device consists of a heavy cable that tethers the computer to the work area. However, such devices are not easy to install. One or more holes must be drilled into the work area to anchor the cable, or the cable must be installed to an immovable object through some other means. The security cable can also interfere with wiring and cables required for operation of the computer, and may be aesthetically undesirable. And, in the end, a motivated thief can simply snip the tether cable with an appropriate tool.

### SUMMARY OF INVENTION

A security device for attachment to a work area for securing an item therein comprises a base configured to be securely mounted to the work area, a cover mounted to the base to define a secure chamber in cooperation with at least one of the base and the work area, wherein the cover is mounted for movement with respect to at least one of the base and the work area between an open position for providing access to the secure chamber and a closed position for preventing access to the secure chamber, and a lock cooperating with the cover and at least one of the base and the work area for selectively locking the cover in the closed position, thereby preventing access to the secure chamber, whereby a computing device can be placed within the secure chamber when the cover is in the open position, and the computing device can be stored within the secure chamber when the cover is moved to the closed position and locked. The work area can be a work surface or a table.

A pan can be mounted to the base whereby the pan defines a bottom surface of the secure chamber. The pan can be fixedly attached to the base, or mounted to the base for movement between a retracted position adjacent the base and an extended position away from the base to provide a convenient working position for a computing device sitting thereon.

A linkage mechanism can be mounted between the base and the pan for movement between a collapsed position and an uncollapsed position wherein, when the linkage mechanism is positioned in the collapsed position, the pan is located in the retracted position, and when the linkage mechanism is positioned in the uncollapsed position, the pan is located in the extended position. The linkage mechanism can comprise a pair of interconnected linkage arms forming a scissors-type mechanism.

The base can further comprise a recess for routing wires from the pan to the exterior of the base. A wire management system can route wires between a computing device positioned on the pan and the base, comprising a series of spaced protrusions on the link mechanism.

A portion of the lock can be located on the pan, and the portion of the lock located on the pan can be used as a handle to move the pan between the retracted and the extended positions. A portion of the lock can be located on the work area.

The base can further comprise a recess for routing wires from the secure chamber to the exterior of the base. A portion of the lock can be located on the cover and a portion of the lock can be located on the base. A portion of the lock can be located on the cover and a portion of the lock can be located on the work area.

The base can be mounted to an upper surface of the work area, an underside of the work area, or an outer surface of the work area. The base can be mounted to the work area by a secure bracket, which can be detached from the work area when the cover is unlocked, but prevented from detachment when the cover is locked. The secure bracket can be adapted so that it cannot be accessed when the cover is locked.

A hand rest can be adapted to be mounted to at least one of the base and the work area. The cover can be mounted to the base by a hinge assembly. The hinge assembly can be configured to maintain the cover in the open position and avoid inadvertent closings thereof. The hinge assembly can laterally move a rear wall of the cover forwardly during movement of the cover from the closed position to the open position,wherein the forward movement of the rear wall of the cover exposes the recess at the rear portion of the base for access to wires contained therein, or can prevent the rear wall of the cover from extending rearwardly beyond a rear wall of the base, allowing the rear wall of the base to be flush-mounted against a vertical surface.

The base can include a recess at a rear portion thereof for routing wires from within the secure chamber to the exterior of the security device.

The item can be a computing device. The computing device can be a laptop computer. When the laptop computer is placed in the secure chamber, the movement of the cover from the open position to the closed portion can close the laptop.

In another embodiment, a security device for attachment to a horizontal work surface for securing a computing device therein comprises a base configured to be securely mounted to the work surface, a cover mounted to the base to define a secure chamber in cooperation with at least one of the base and the work surface, wherein the cover is mounted for movement with respect to the base between an open position for providing access to the secure chamber and a closed position for preventing access to the secure chamber, and a lock cooperating with the cover and at least one of the base and the work surface for selectively locking the cover in the closed position, thereby preventing access to the secure chamber, whereby a computing device can be placed within the secure chamber when the cover is in the open position, and the computing device can be stored within the secure chamber when the cover is moved to the closed position and locked.

### BRIEF DESCRIPTION OF DRAWINGS

In the drawings:

FIG. 1 is a perspective view of a first embodiment of laptop computer security device attached to a work area and comprising a closed locking cover, a base assembly, and a hand rest assembly adapted to enclose an unused laptop computer.

FIG. 2 is a perspective view of the embodiment illustrated in FIG. 1 with the cover in an open position.

FIG. 3 is an exploded view of the embodiment illustrated in FIG. 1.

FIG. 4 is an exploded close-up view of a hinge assembly comprising a portion of the base assembly illustrated in FIG. 3 for pivotably attaching the cover to the base assembly.

FIG. 5 is a sectional view of the hinge assembly illustrated in FIG. 4 in an assembled configuration taken along line 5-5.

FIG. 6 is a perspective view of the underside of the embodiment illustrated in FIG. 1.

FIG. 7 is a perspective view of a second embodiment of the laptop computer security device attached to a work area and comprising a closed cover having a lock which engages a strike mounted in the work area adapted to enclose an unused laptop computer.

FIG. 8 is a perspective view of the second embodiment illustrated in FIG. 7 with the cover in an open position showing an enclosed laptop computer.

FIG. 9 is a plan view of the work area showing the strike.

FIG. 10 is an exploded view of the embodiment illustrated in FIG. 7.

FIG. 11 is a perspective view of the underside of the embodiment illustrated in FIG. 7 with the work area removed for clarity and showing a cable housing for mounting to the work area and pivotably attaching the cover.

FIG. 12 is a close-up perspective view of the cable housing illustrated in FIG. 11.

FIG. 13 is a close-up perspective view of a portion of the underside of the cover illustrated in FIG. 7 showing brackets for mounting the cover to the cable housing.

FIG. 14 is a perspective view of the embodiment illustrated in FIG. 7 showing the laptop computer connected through suitable cables to a remote keyboard and a mouse, and connected through suitable cables to a power supply and a network connection.

FIG. 15 is a perspective view of the embodiment illustrated in FIG. 1 mounted to two adjoining work areas to form a 45° degree work station.

FIG. 16 is an exploded view of a third embodiment of the laptop computer security device comprising a movable support pan for extending the laptop computer to a use position.

FIG. 17 is a perspective view of the embodiment illustrated in FIG. 16 with the movable support pan in a retracted position.

FIG. 17A is an enlarged perspective view of a hinge assembly comprising a portion of the embodiment illustrated in FIG. 17.

FIG. 18 is a perspective view of the embodiment illustrated in FIG. 16 with the movable support pan moved to an extended position through a scissors-type extender.

FIG. 19 is an enlarged first perspective view of the scissors-type extender illustrated in FIG. 18 comprising a plurality of cable pin assemblies for routing cables from the laptop computer to the exterior of the laptop computer security device.

FIG. 20 is an enlarged second perspective view of the cable pin assemblies illustrated in FIG. 19 extending from the laptop computer security device.

FIG. 21A is an enlarged rear perspective view of a portion of the security device illustrated in FIG. 16 showing the attachment of the security device to the work area utilizing a first embodiment of a clamp assembly.

FIG. 21B is an enlarged rear perspective view of the portion of the security device illustrated in FIG. 16 showing the attachment of the security device to the work area utilizing a second embodiment of a clamp assembly.

### DETAILED DESCRIPTION

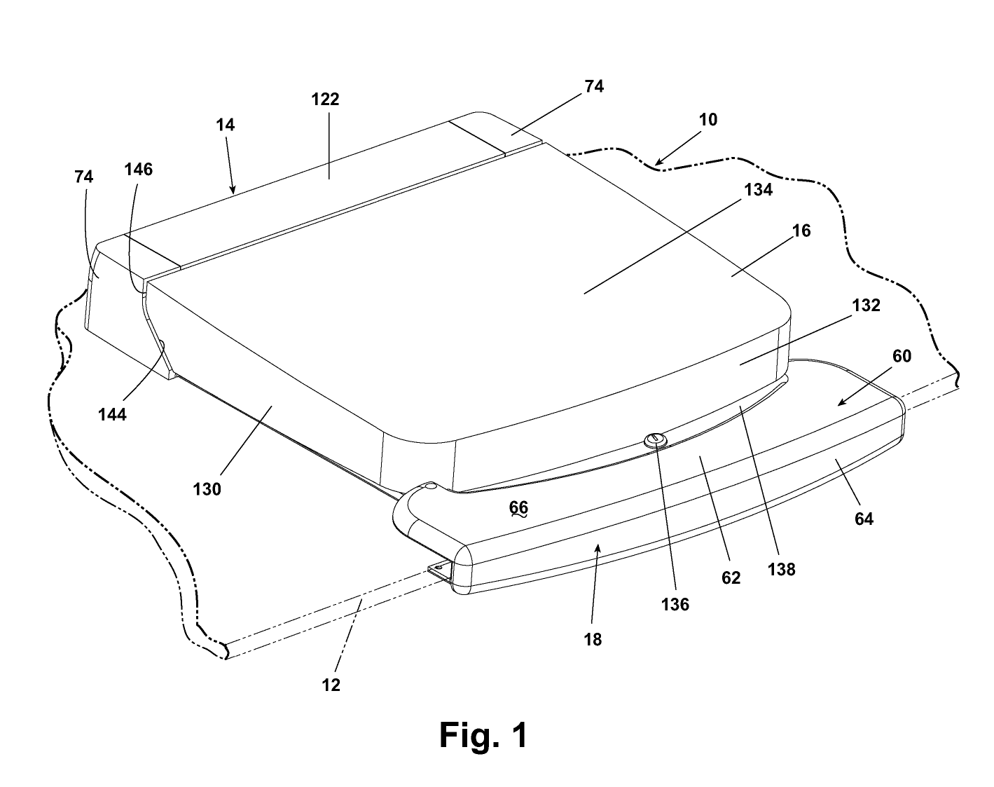

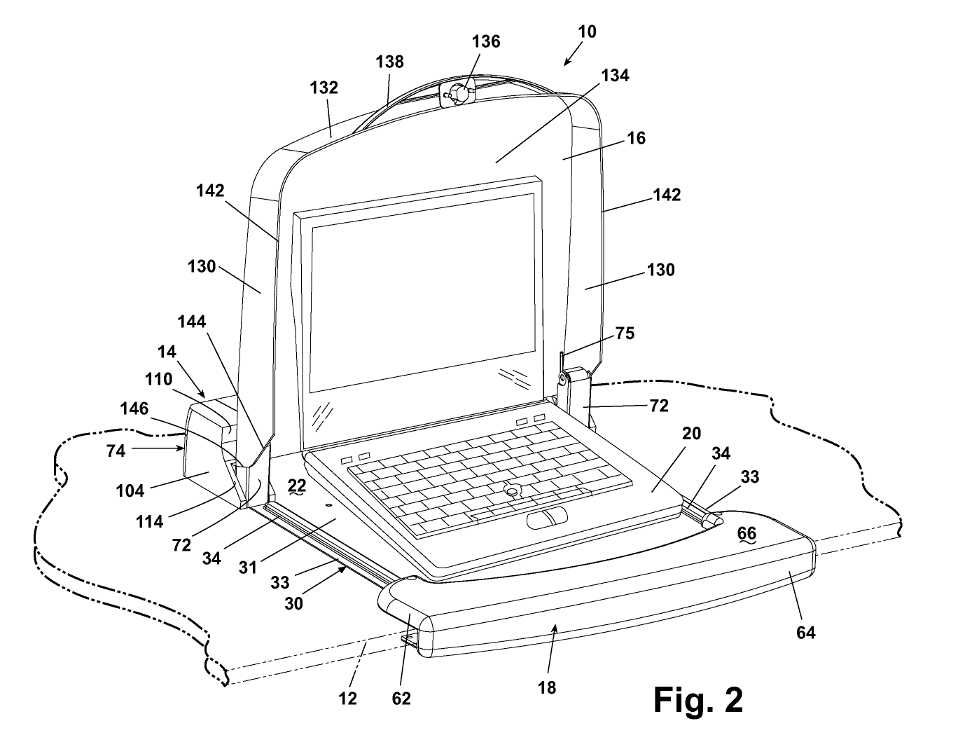

Referring now to the drawings, and in particular to FIGS. 1 and 2, a first embodiment of a security device 10 is illustrated attached to a surface of a conventional work area 12 and comprising a base assembly 14, a locking cover 16 pivotably attached to the base assembly 14, and a hand rest assembly 18. The embodiments of the security device described herein are illustrated as accommodating a laptop computer. However, the security device can be utilized for securing other workplace items such as a calculator, an adding machine, a communication device such as a radio, a telephone, and the like.

The security device 10 defines a chamber 22 (FIG. 2) for enclosing a laptop computer 20 when the cover 16 is pivoted to a closed position, and exposes the computer 20 for use by a worker when the cover 16 is pivoted to an open position. The hand rest assembly 18 preferably provides an ergonomic, cushioned surface for supporting the worker's hands or forearms during use of the computer 20 in a manner well known in the art.

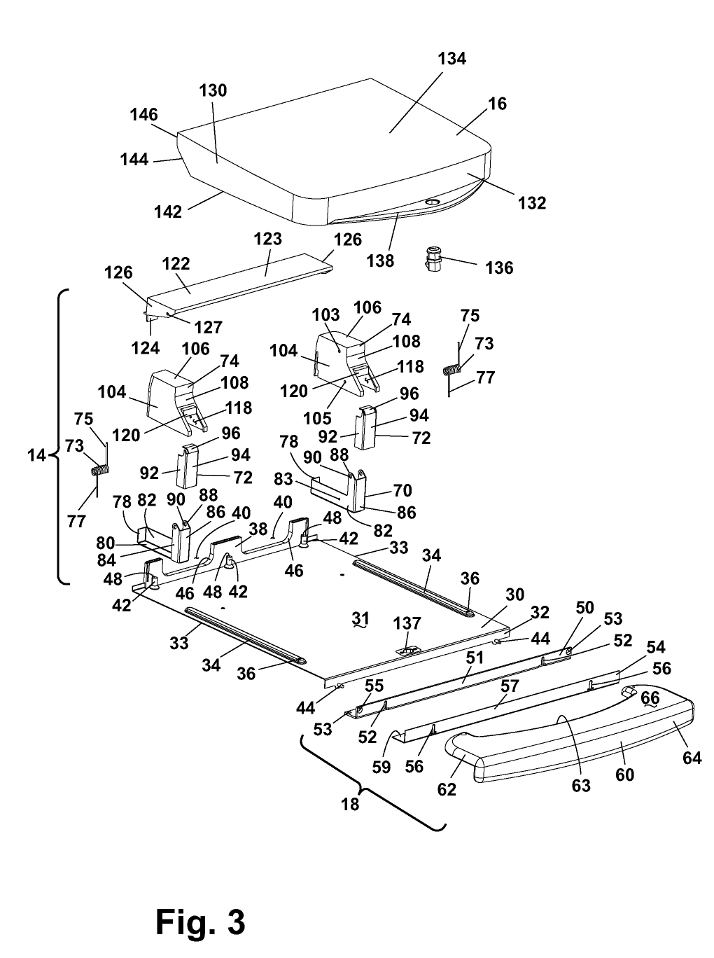

Referring also to FIG. 3, the laptop security device 10 comprises a pan 30 having a planar support surface 31 on which the laptop computer 20 rests, and a hinge assembly 68 for mounting the cover 16 to the pan 30 for pivotal movement of the cover 16 between an open position and a closed position. The pan 30 is a generally rectilinear plate-like piece having a front edge terminating in a downwardly extending front flange 32 orthogonal to the support surface 31. The support surface 31 terminates in a pair of spaced-apart, parallel side edges 33 extending orthogonal to the front flange 32. A pair of raised side ribs 34 is formed in the pan 30 and extends parallel and adjacent to the side edges 33 above the support surface 31. A hand rest mounting aperture 36 extends through the pan 30 at a forward end of each side rib 34.

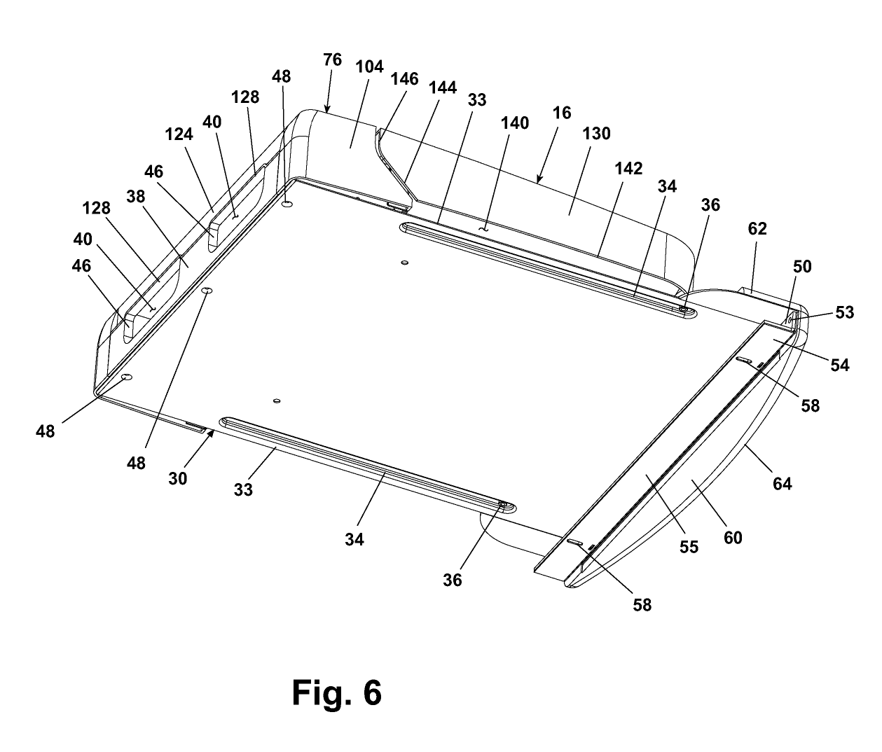

As illustrated also in FIG. 6, the pan 30 has a rear edge terminating in an upwardly extending rear flange 38 orthogonal to the support surface 31. A plurality of regularly spaced, generally cylindrical mounting posts 42 are mounted to the pan 30 immediately adjacent to the rear flange 38 and extending orthogonally upwardly from the support surface 31. A mounting aperture 48 extends coaxially through each mounting post 42 and the pan 30. The rear flange 38 is provided with a pair of flange openings 46 to define a pair of cable ports 40.

The hand rest assembly 18 is attached to the front flange 32 and comprises a mounting angle 50, a cover angle 54, and a hand rest 60. The mounting angle 50 comprises an elongated, L-shaped member having a vertical leg 51 and a horizontal leg 55 orthogonal thereto. A pair of peg slots 52 extends through the vertical leg 51 spaced inwardly from either end of the mounting angle 50. A pair of mounting apertures 53 extends through the vertical leg 51 adjacent either end of the mounting angle 50. A pair of elongated mounting apertures 58 extend through the horizontal leg 55 spaced inwardly from either end of the mounting angle 50. The mounting angle 50 is preferably made from steel or other suitably rigid, structural material and can have a resilient material added to its inside surfaces for cushioning purposes.

The cover angle 54 comprises an elongated, L-shaped member having a vertical leg 57 and a horizontal leg 59 orthogonal thereto. A pair of peg slots 56 extends through the vertical leg 57 spaced inwardly from either end of the cover angle 54. The hand rest 60 is a generally L-shaped member having a top portion 62 and a depending front portion 64 orthogonal thereto. The top portion 62 has a planar top surface 66 and a generally arcuate cutout portion 63.

The front flange 32 of the pan 30 is provided with a pair of spaced-apart, cylindrical mounting pegs 44 extending outwardly from the front flange 32 and spaced inwardly from either end thereof. The mounting pegs 44 are adapted to be inserted into the peg slots 52, 56. The mounting angle 50 is adapted to be fixedly attached to the work area 12 by fasteners (not shown), such as wood screws or other threaded fasteners, inserted through the mounting apertures 53 into an edge of the work area 12. The hand rest 60 is fixedly attached to the pan 30 by fasteners (not shown), such as screws or other threaded fasteners, inserted through the mounting apertures 36 into mating receptacles in the underside of the top portion 62 of the hand rest 60.

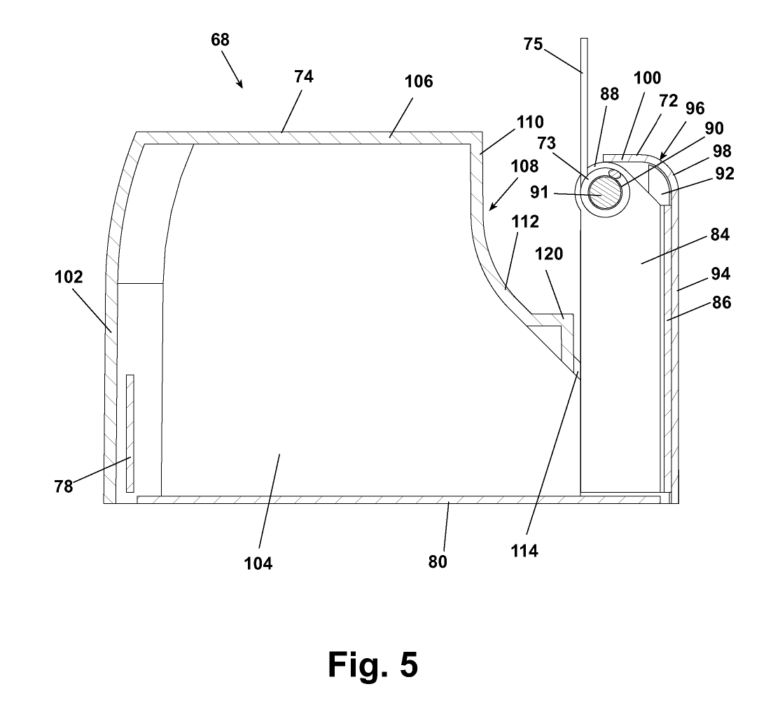

The base assembly 14 comprises a hinge assembly 68 and a rear cover 122. As illustrated in FIGS. 3, 4, and 5, the hinge assembly 68 comprises a bracket hinge 70, a spring cover 72, a spring and 73, and a cover bracket 74. The bracket hinge 70 is a generally elongated, rectilinear, L-shaped body comprising a bottom wall 80 having a rear wall 78, a side wall 82, a side flange 84, and a front wall 86 extending upwardly orthogonally therefrom, the rear wall 78 and the front wall 86 being in generally parallel, spaced-apart juxtaposition, and the side wall 82 and the side flange 84 being in generally parallel, spaced-apart juxtaposition. Extending upwardly from the sidewall 82 and the side flange 84 are a pair of ears 88 having a pin aperture 90 extending therethrough for slidable receipt of a pin 91. Extending through the sidewall 82 is an aperture 83.

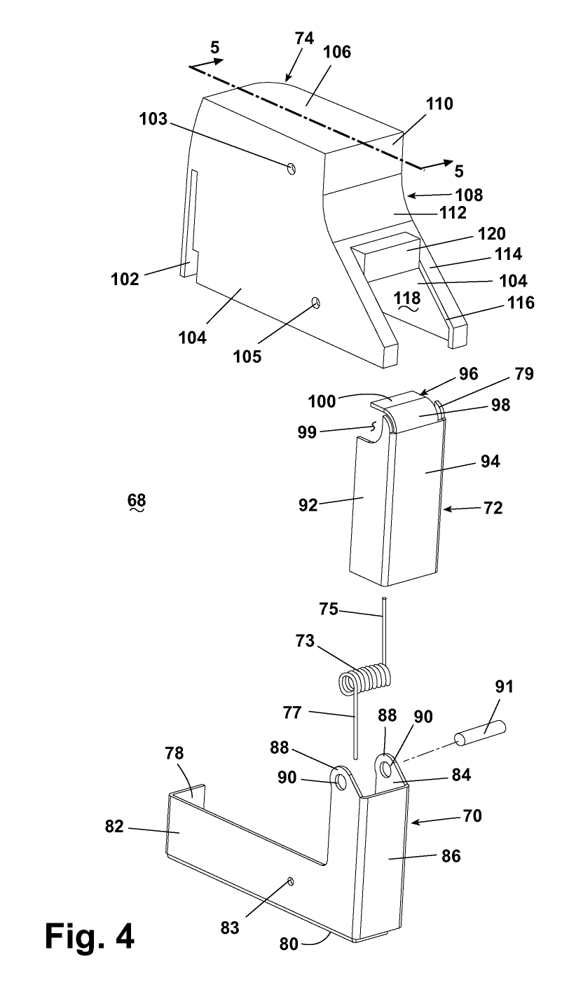

The spring cover 72 is an upwardly standing, elongated, rectilinear body comprising a pair of generally parallel, spaced-apart side flanges 92 and a front wall 94 extending orthogonally therebetween. The front wall 94 terminates in an upwardly-extending spring arm 96 comprising a curved portion 98 attached to the front wall 94 and transitioning into a straight portion 100 generally orthogonal to the front wall 94. The spring arm 96 is spaced away from a side flange 92 to form a spring slot 79 therebetween. The spring arm 96 extends upwardly away from the side flanges 92 to define a spring gap 99 therebetween, as illustrated in FIG. 4.

The cover bracket 74 is a generally rectilinear, hollow body comprising a rear wall 102, a pair of parallel, spaced-apart side walls 104, and a top wall 106, the rear wall 102, the side walls 104, and the top wall 106 being in generally orthogonal juxtaposition. Extending downwardly from the top wall 106 and between the side walls 104 is a front wall 108 comprising a straight portion 110, transitioning through a curved portion 112 to terminate in an inclined wall 114. An opening 116 extends through the inclined wall 114 to define a spring cover slot 118 for slidable receipt of the bracket hinge 70 and the spring cover 72. At the upper terminus of the spring cover slot 118 is a spring block 120. Extending through an upper portion of the sidewall 104 is an upper aperture 103. Extending through a lower portion of the sidewall 104 is a lower aperture 105.

The spring 73 is a helical wire spring terminating in an upwardly extending upper leg 75 and a downwardly depending lower leg 77.

The rear cover 122 is a generally L-shaped, elongated member having a top wall 123, a back wall 124, and a pair of generally parallel, spaced-apart side walls 126 in generally orthogonal juxtaposition. The side walls 126 are provided with an aperture 127 therethrough. The back wall 124 is provided with a wall opening 128 in corresponding relationship with the flange openings 46 in the rear flange 38 of the pan 30 to define the cable ports 40.

The cover 16 comprises a pair of generally parallel, spaced-apart sidewalls 130 depending downwardly from a planar top wall 134. A front wall 132 depends from the top wall 134 to extend between the sidewalls 130. Extending outwardly from the front wall 132 in generally parallel relationship to the top wall 134 is a cover flange 138 in which is installed a generally conventional slam lock 136. The slam lock 136 is adapted to operably communicate with a strike 137 installed in the pan 30. The side walls 130 terminate along the size of the cover 16 in a pair of side wall edges 142, and at the rear of the cover 16 in a pair of back inclined edges 144 and a pair of back vertical edges 146 adapted for corresponding juxtaposition with the front wall 108 of the cover bracket 74.

Referring specifically to FIGS. 4, 5, and 6, the hinge assembly 68 is attached to the pan 30 as follows. The bracket hinge 70 is fixedly attached to the pan 30 in a generally conventional manner, such as with threaded fasteners, spot welds, or other suitable fastening means. The cover bracket 74 is inserted over the bracket hinge 70 is so that the side wall 82 extends between the side walls 104 and the ears 88 extend upwardly out of the spring cover slot 118. A fastener (not shown), such as a rivet, machine screw, or other threaded fastener, is then inserted through the lower aperture 105 into the aperture 83 to secure the bracket hinge 70 to the cover bracket 74. The spring 73 is inserted between the ears 88 so that the lower leg 77 can bear against the spring block 120, and held in place with the pin 91 inserted through the pin apertures 90 and the spring 73. The spring cover 72 is then inserted over the bracket hinge 70 with the spring arm 96 extending over the spring 73 and the upper leg 75 extending through the spring slot 79. The pin 91 can also extend into suitable mating receptacles in the cover 16 to provide a pivot point for the cover 16. Alternatively, the pin 91 can be an integral part of the cover 16. As illustrated in FIG. 2, the assembly of the cover 16 to the hinge assembly 68 will result in the upper leg 75 bearing against the top wall 134 of the cover 16. A rib, boss, or other bearing structure can be incorporated into the cover 16 to provide a reinforced bearing surface for the upper leg 75. When the cover 16 is closed, the upper leg 75 will be urged from a vertical to a horizontal position, placing the spring 73 in torsion. When the cover 16 is opened, the spring 73 will urge the cover 16 to a vertical position.

As illustrated in FIG. 6, when the cover 16 is closed, the side wall edges 142 will be spaced somewhat away from the side edges 33 of the pan 30 to form a cable slot 140 through which wiring or cables, such as a mouse cable, a keyboard cable, or other computer peripheral cables, can be run.

The rear cover 122 is attached to the cover brackets 74 by threaded fasteners inserted through the apertures 127 in the side walls 126 of the rear cover 122 into the upper apertures 103 in the cover brackets 74. The rear cover 122 can be readily removed to accommodate a docking station (not shown) having a height greater than the height of the laptop security device 10. With the rear cover 122 removed, the rear flange 38 will prevent removal of the laptop computer 20 through the rear of the security device 10.

The security device 10 is attached to a work area 12 as follows. The pan 30 is placed on the work area 12 so that the front flange 32 is preferably in contact with an edge of the work area 12. The mounting angle 50 is attached to the work area with the vertical leg 51 in contact with the front flange 32 so that the mounting pegs 44 extending through the pegs slots 52 and the horizontal leg 55 in contact with the underside of the work area 12. Threaded fasteners (not shown) are inserted through the mounting apertures 53 into the work area to secure the mounting angle 50 to the work area 12. The cover angle 54 is then inserted over the mounting angle 50 so that the mounting pegs 44 extend through the pegs slots 56. Additional threaded fasteners (not shown) can also be passed through the pan 30 and into the worksurface as needed for a secure mounting of the pan 30 to the work area 12.

Legs 51 and 55 of mounting angle 50 are preferably of unequal length as are the corresponding legs 57 and 59 of cover angle 54. The orientation of mounting angle 50 and cover angle 54 can be reversed as desired to accommodate varying worksurface thicknesses. For example, worksurface thicknesses may range from ¾″-1-½″ and varying the orientation of the mounting angle 50 and cover angle 54 to position the corresponding set of legs 51, 57 or 55, 59 whose length more particularly corresponds to the thickness of the worksurface on which the security device 10 is to be mounted can provide additional flexibility. In this manner, the laptop security device 10 can be mounted to more and widely varying types of worksurfaces due to the adjustable nature of the mounting angle 50 and cover angle 54.

The hand rest 60 is attached to the pan 30 by threaded fasteners (not shown) extending through the mounting apertures 36 into the underside of the top portion 62 of the hand rest 60.

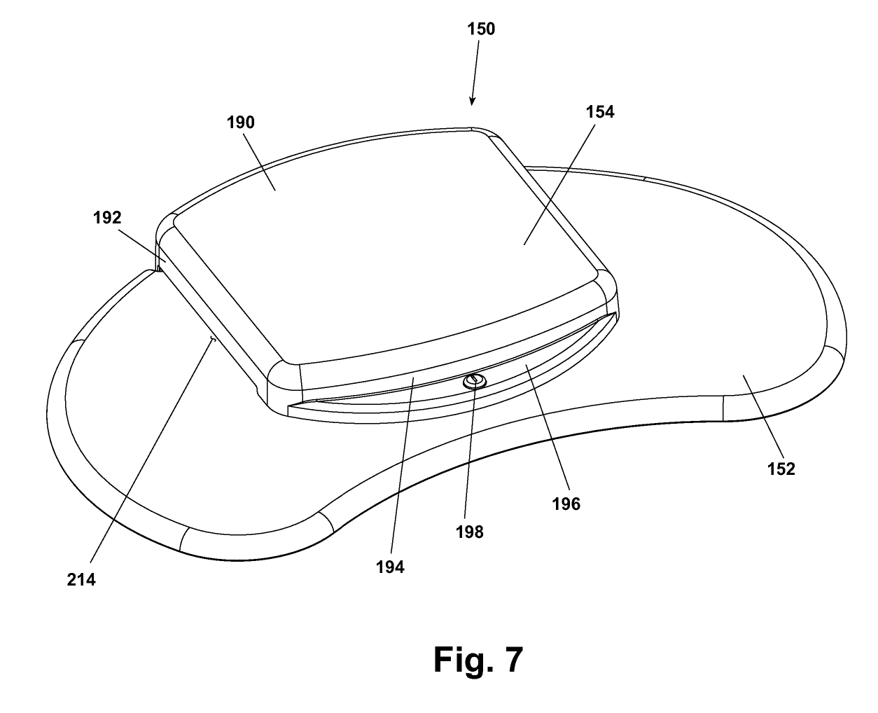

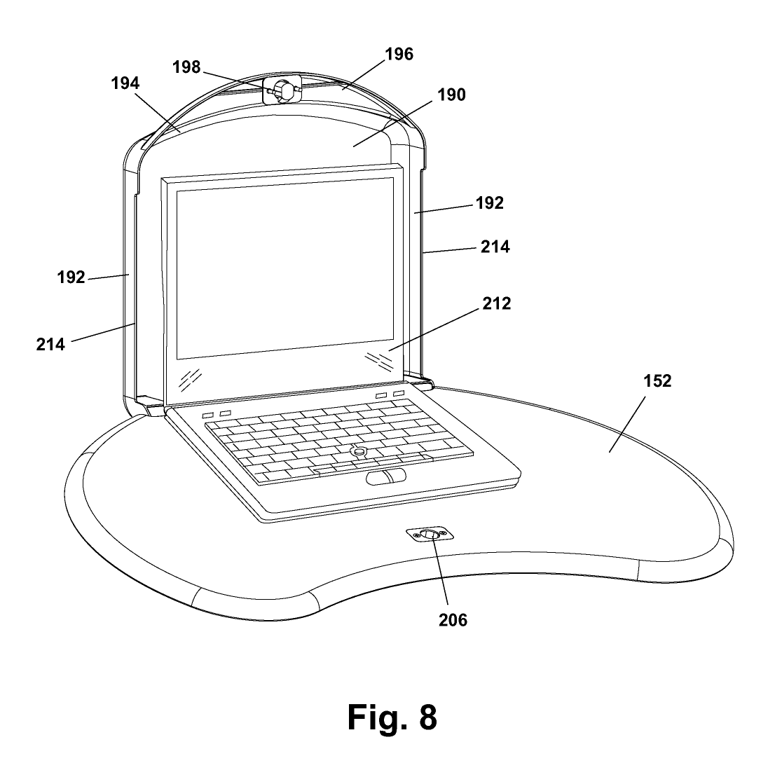

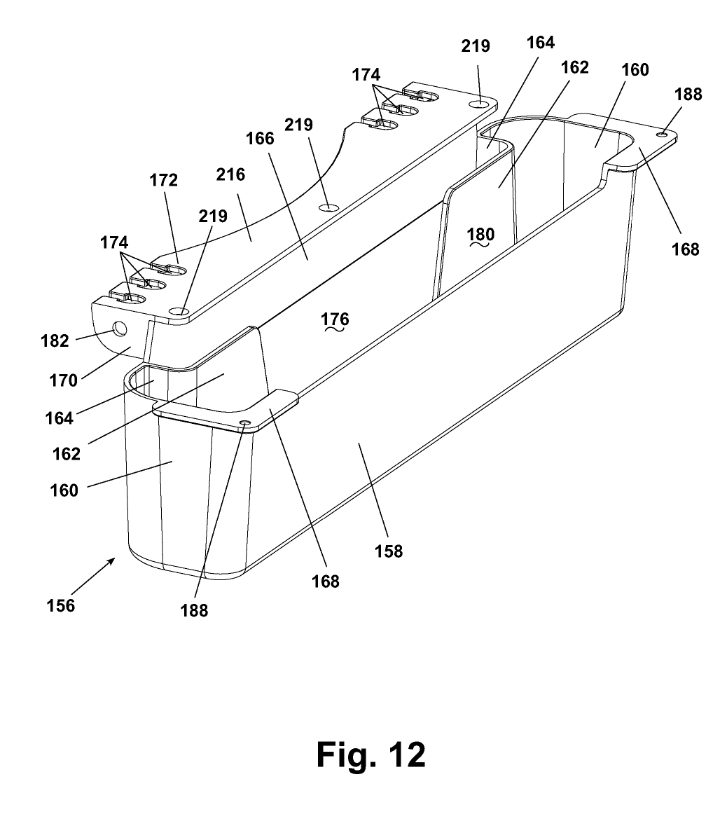

As can be seen from the drawings and appreciated herein, the fasteners which mount the security device 10 to the work area 12 are either concealed within the pan 30 or located beneath a cover (such as cover angle 54). In this manner, a thief cannot simply remove the laptop security device from the work area 12 because the attachment fasteners/devices are not readily accessible unless the cover 16 is in the opened position. In addition, the components making up the laptop security device 10 are mounted to one another in a manner which does not expose the attachment fasteners/devices to the exterior of the laptop security device for the same reasons. The same mounting concepts hold true for the second embodiment illustrated in FIGS. 7-13.

The second embodiment 150 of a laptop security device is illustrated in FIGS. 7-13. The laptop security device 150 is illustrated attached to a work area 152 such as a mobile workstation. However, the security device 150 can be readily utilized in a conventional permanent workstation. The security device 150 comprises a cover 154, which extends over the top of the work area 152 to define a chamber 155, and a cable housing 156, which is suspended beneath the work area 152.

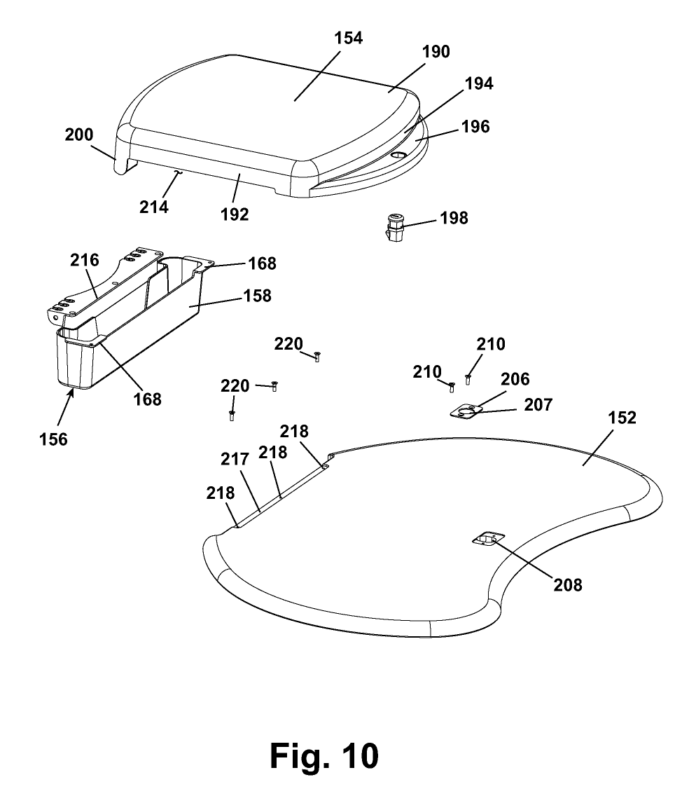

As illustrated in FIGS. 10-12, the cable housing 156 is a generally rectilinear, tub-shaped body comprising a front wall 158, a pair of generally parallel, spaced-apart outer side walls 160, transitioning to a pair of generally parallel, spaced-apart inner side walls 164, in turn the transitioning to an intermediate wall 162 and a back wall 166, to define a cable chamber 180. Extending orthogonally from the corners formed by the intersection of the outer sidewalls 160 and the front wall 158 are a pair of mounting flanges 168 having mounting apertures 188 therethrough, and adapted to communicate with the underside of the work area 152. Suitable fasteners 222, such as screws or other threaded fasteners, are inserted through the mounting apertures 188 into the underside of the work area 152 to attach the mounting flanges 168 to the work area 152.

Extending orthogonally rearwardly of the back wall 166 are a pair of cover flanges 170 with pivot apertures extending therethrough. Extending orthogonally from the top of the back wall 166 to extend over the upper surface of the work area 152 is a flange comprising a cable flange 172 and a top flange 216.

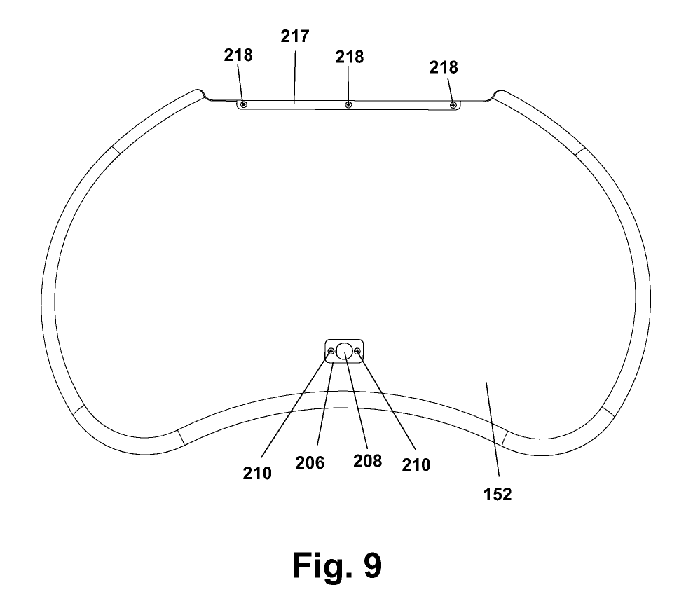

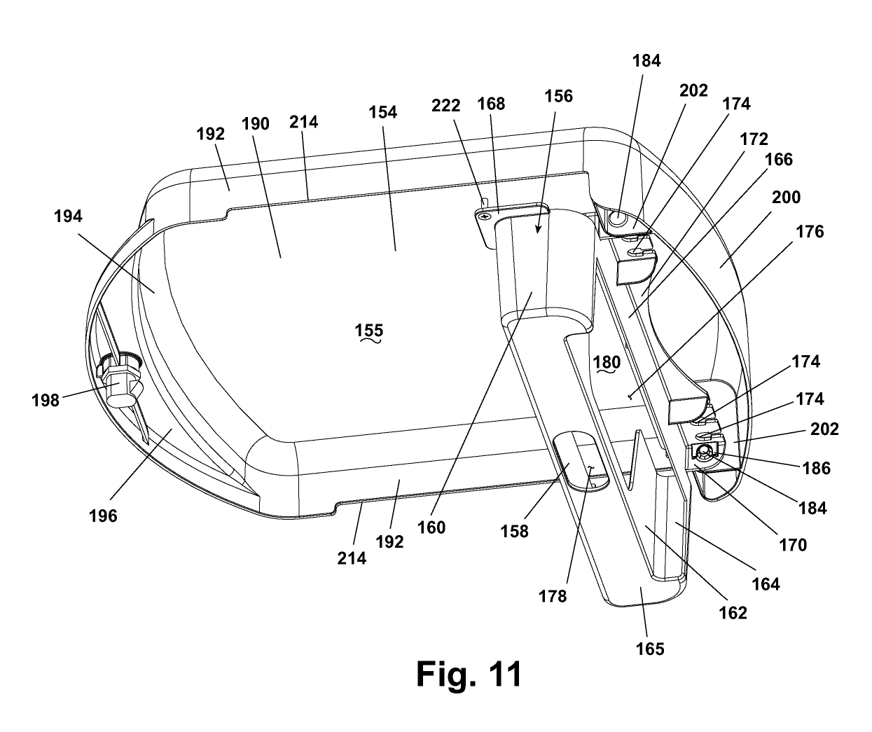

The cable flange 172 is provided with a plurality of cable slots 174 through which computer wiring and the cables can extend. A plurality of mounting apertures 219 extends through the top flange 216. Referring specifically to FIGS. 9 and 10, the work area 152 is provided along a rear edge thereof with a flange cutout 217 adapted to receive the top flange 216 for flush mounting of the top flange 216 to the work area 152 through fasteners 220 inserted through the mounting apertures 219 into mounting apertures 218 in the flange cutout 217. A cable access opening 176 is formed in the intermediate wall 162 for routing of cables and wiring between the laptop computer 212, the cable housing 156, and a power supply or network interface. As illustrated in FIG. 11, a cable outlet opening 178 is provided in a bottom wall 165 of the cable housing 156 for additional routing of cables and wiring.

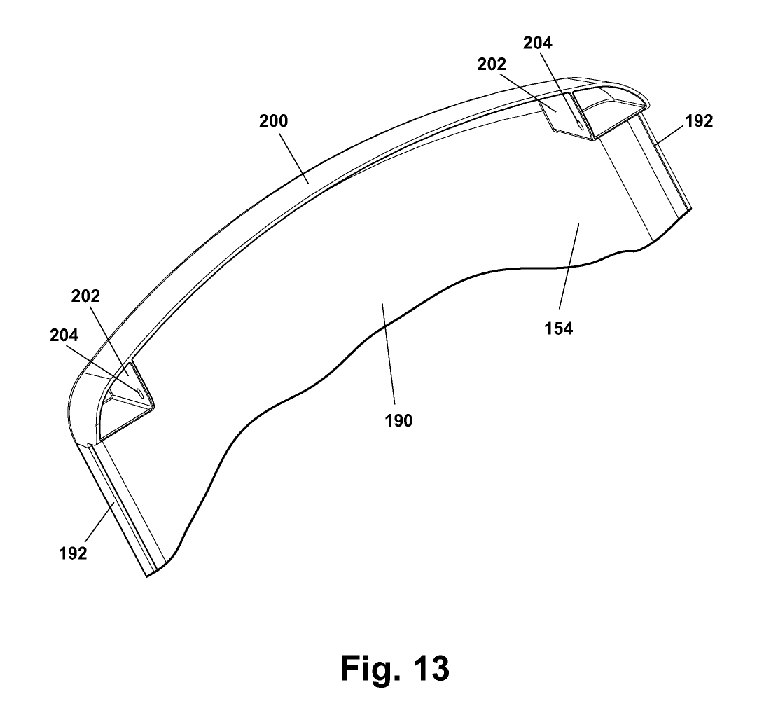

As illustrated in FIGS. 11 and 13, the cover 154 is provided at a rear portion thereof with a pair of spaced-apart mounting flanges 202 having pivot apertures 204 therethrough. The cover 154 is attached to the cable housing 156 by a suitable fastener, such as pivot pins 184 extending through the pivot apertures 204 and the pivot apertures 182, and secured with a friction nut 186. Alternatively, threaded fasteners, rivets, or other suitable fasteners can be employed.

The cover 154 comprises a top wall 190, a pair of generally parallel, spaced-apart sidewalls 192, a front wall 194, and a rear wall 200 into generally rectilinear juxtaposition. Extending outwardly from the front wall 194 is a cover flange 196 having a generally conventional slam lock 198 extending therethrough. The side walls 192 are provided with a cutout portion to define a cable slot 214 extending therethrough between the side walls 192 and the work area 152 for routing of cables and wiring from the laptop computer 212 when the cover 154 is in a closed and locked position. As illustrated in FIG. 9, the work area 152 is provided with a strike 206 having a lock hole 207 therethrough and fastened to the work area 152 with suitable fasteners 210, such as screws or other threaded fasteners. The work area 152 is provided with a lock bore 208 in corresponding relationship with the lock hole 207 for locking receipt of the slam lock 198.

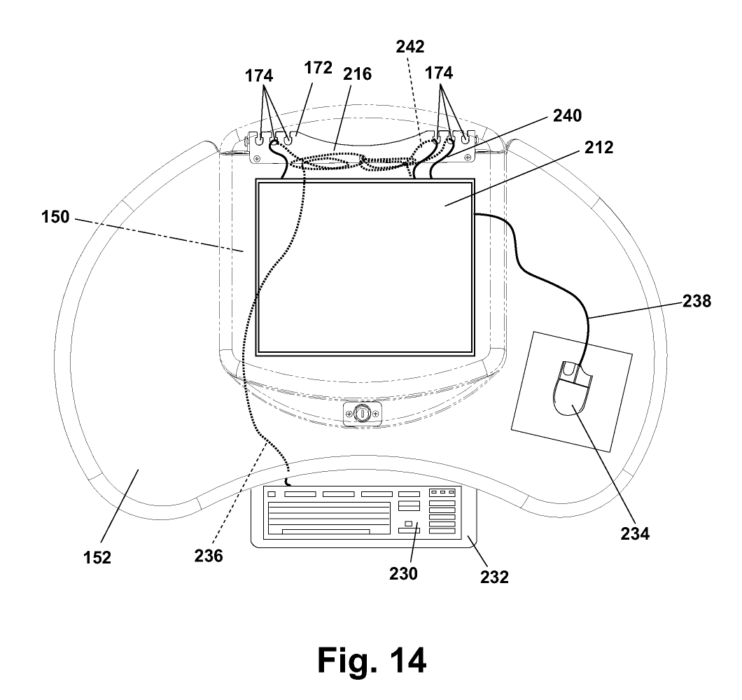

As illustrated in FIG. 14, and exemplary laptop computer 212 is illustrated with an external keyboard 230 supported on a retractable keyboard support 232 attached to the underside of the work area 152. The keyboard 230 is attached to the laptop computer 212 through a keyboard cable 236 which is routing beneath the work area 152 into the cable housing 156, through the cable slots 174 into the appropriate port in the laptop computer 212. Excess cable is concealed in the cable housing 156. Similarly, a mouse 234 is attached to the laptop computer 212 through a mouse cable 238 which extends through the cable slot 214 into the appropriate port in the laptop computer 212. A power cable 240 and the network cable 242 extending from the appropriate ports in the laptop computer 212 through the cable slots 174 through the cable housing 156 to be connected to the appropriate power supply or network interface. Excess cable 240, 242 is concealed in the cable housing 156.

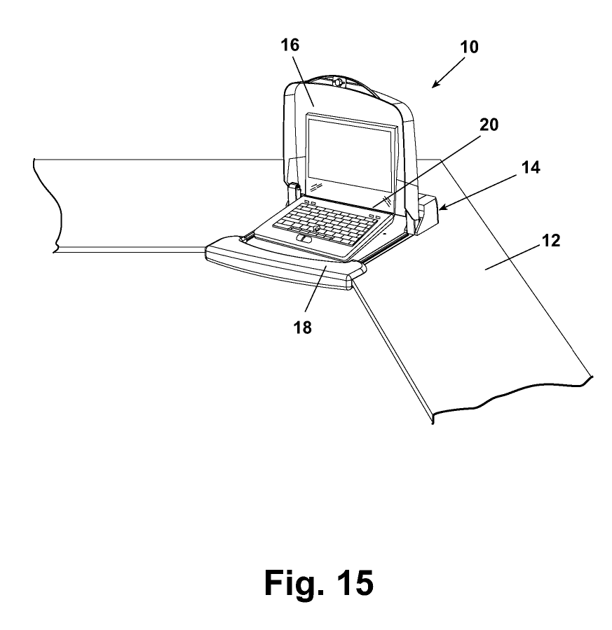

As illustrated in FIG. 15, the first embodiment 10 of the laptop security device can be readily mounted to an interior corner formed by the intersection of two work areas 12. Preferably, the security device 10 can be mounted at a 45-degree angle to the work areas 12 to provide a convenient workstation. The attachment of the security device 10 in this configuration is essentially the same as previously described herein.

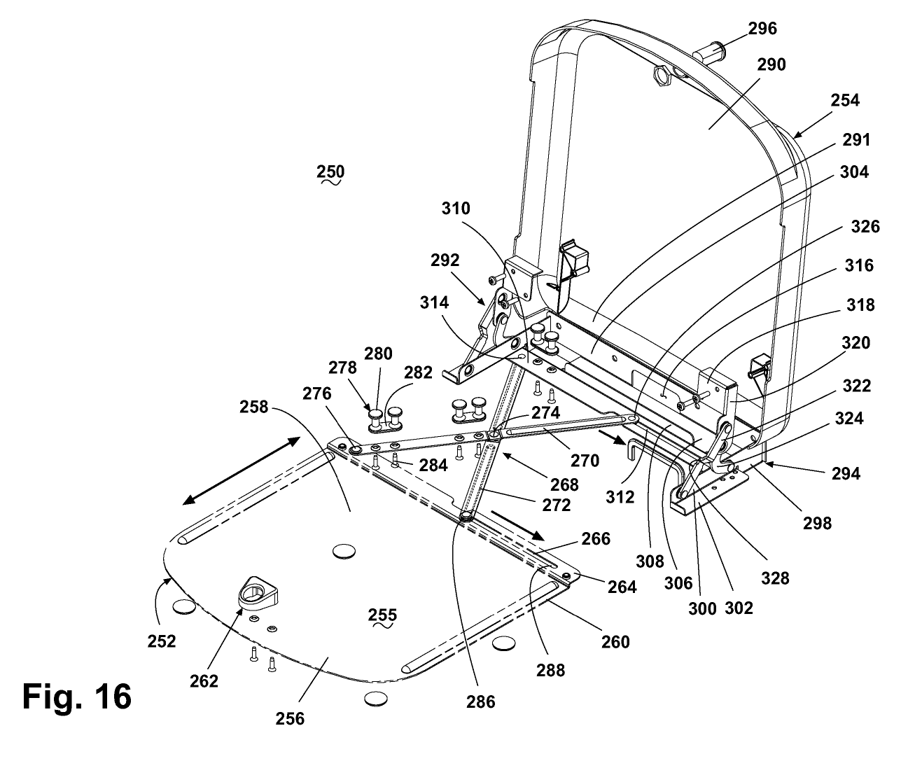

FIG. 16 illustrates a third embodiment of the laptop security device 250 which is similar in many respects to the two embodiments described herein, and which comprises a movable pan assembly 252, and a cover assembly 254. The pan assembly 252 comprises a plate-like pan 256 having a top surface 258 facing the cover assembly 254, and an opposed bottom surface 260. The pan 256 is provided with a strike 262 at a proximal end of the pan 256. The pan 256 terminates at a distal end in a scissors flange 264 which is parallel to and spaced somewhat above the top surface 258. The scissors flange 264 is provided with a longitudinal slot 266 extending along approximately half the scissors flange 264 to terminate at an outer end 288.

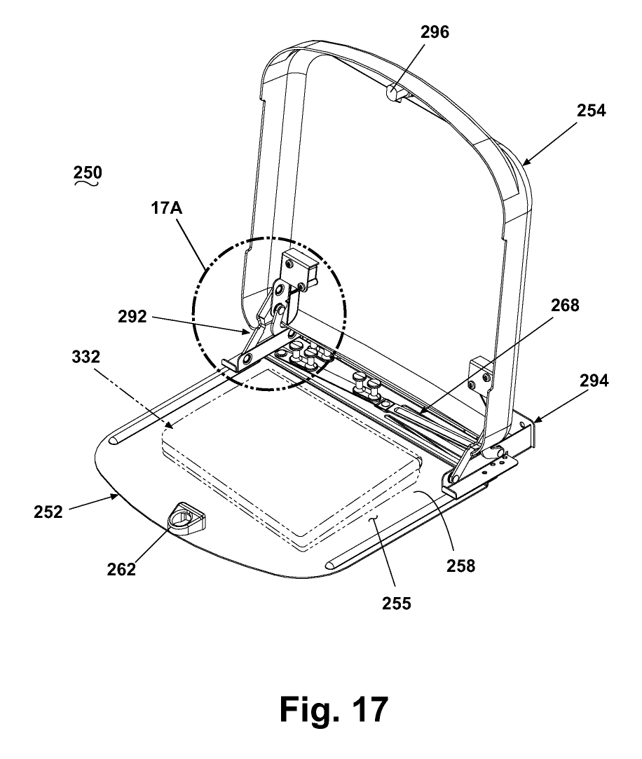

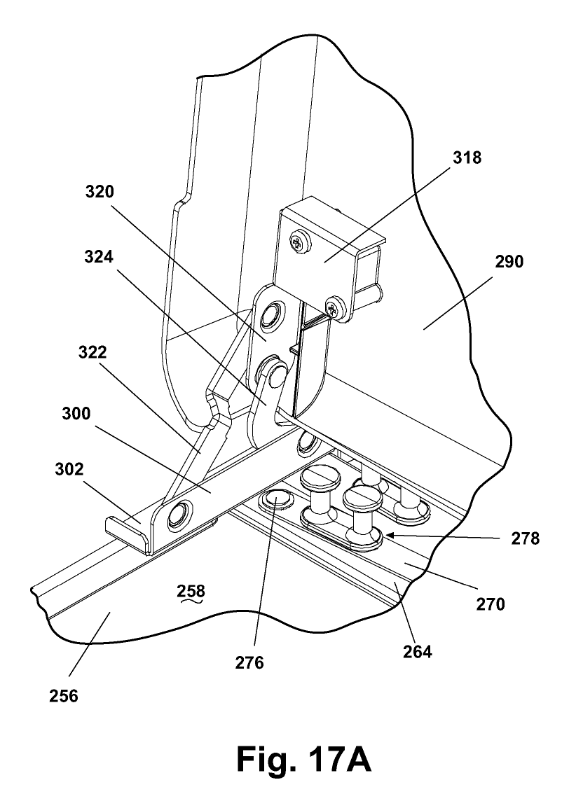

An extender 268 comprises an upper linkage arm 270 and a lower linkage arm 272 joined to form a linkage mechanism. Both arms 270, 272 comprising elongated, straplike members joined together at their center points by a pivot connection 274 which enables the upper linkage arm 270 and the lower linkage arm 272 to pivot relative to each other. The upper linkage arm 270 is attached at a first end to the scissors flange 264 through a pivot connection 276. The lower linkage arm 272 is attached at a first end to the scissors flange 264 through a slot connector 286 which is adapted for slidable translation along the slot 266. The extender 268 can move from a collapsed configuration, in which the upper linkage arm 270 is generally in longitudinal register with the lower linkage arm 272 and the slot connector 286 is moved to the outer end 288 of the slot 266 (FIG. 17), to an extended configuration, in which the upper linkage arm 270 and the lower linkage arm 272 form a cross-shaped configuration (FIG. 18).

The cover assembly 254 comprises a cover 290 having a back wall 291 and adapted to move from an open position to a closed position to enclose a laptop computer 332 within a chamber 255, and having a lock 296 for cooperative register with the strike 262. The cover assembly 254 also comprises a hinge assembly 292 and a cable compartment 294.

The cable compartment 294 is a generally elongated, rectilinear structure comprising a pair of parallel, spaced-apart sidewalls 298, a back wall 304 extending orthogonally therebetween, a bottom wall 306 extending orthogonally between the sidewalls 298 and the back wall 304, and a front wall 308 extending orthogonally from the bottom wall 306 in parallel, spaced-apart juxtaposition with the back wall 304. The back wall 304 is provided with a cable opening 316 extending therethrough.

Extending forward of the front wall 308 is a plate-like scissors flange 310. The plane of the scissors flange 310 extends somewhat above the plane of the bottom wall 306 and parallel thereto. The scissors flange 310 is provided with a longitudinal slot 312 extending along approximately half the scissors flange 310 to terminate at an outer end 328. The upper linkage arm 270 is attached at a second end to the scissors flange 310 through a pivot connection 314. The lower linkage arm 272 is attached at a second end to the scissors flange 310 through a slot connector 326 which is adapted for slidable translation along the slot 312. When the extender 268 is in the collapsed configuration, the slot connector 326 is moved to the outer end 328 of the slot 312.

The sidewalls 298 are generally plate-like bodies terminating in a forward-extending hinge plate 300 and a plate-like flange 302 extending orthogonally outwardly from the hinge plate 300. The plane of the flanges 302 extends somewhat above the plane of the bottom wall 306 and coplanar with the scissors flange 310 so that the flanges 302 overlie the pan 256 when the pan 256 is moved to the collapsed configuration (FIG. 17).

Referring now to FIG. 17A, the hinge assembly 292 comprises a hinge bracket 318, a forward arm 322, and a rear arm 324. The hinge bracket 318 is a rectilinear, somewhat box-like structure adapted for fixed attachment to the cover 290, and comprising a hinge plate 320 extending along one edge therefrom. The forward arm 322 comprises an elongated, strap-like body having opposed, offsetting portions. The rear arm 324 is a flat, somewhat L-shaped body. The forward arm 322 is pivotably attached at a lower end to a forward outer portion of the hinge plate 300, and at an upper end to an upper outer portion of the hinge plate 320. The rear arm 324 is pivotably attached at a lower end to a rear outer portion of the hinge plate 300, and at an upper end to a lower inner portion of the hinge plate 320. The offsetting portions of the forward arm 322 are adapted to accommodate the clearance required by the movement of the lower linkage arm 324 and the hinge plate 320 as the cover 290 moves from an open position to a closed position.

The configuration of the hinge assembly 292 enables the cover 290 to translate in a forward direction as the cover 290 is opened in order to expose the cable compartment 294 and facilitate access thereto. As the cover 290 is moved to a closed position, the hinge assembly 292 translates the cover 290 in a rearward direction so that the cover 290 extends over the cable compartment 294 and the back wall 291 is aligned coplanar with the back wall 304. This translational movement of the cover 290 also enables the laptop security device 250 to be mounted flush against a vertical surface, such as a wall, or the back of a workspace, without interfering with the opening and closing of the cover 290.

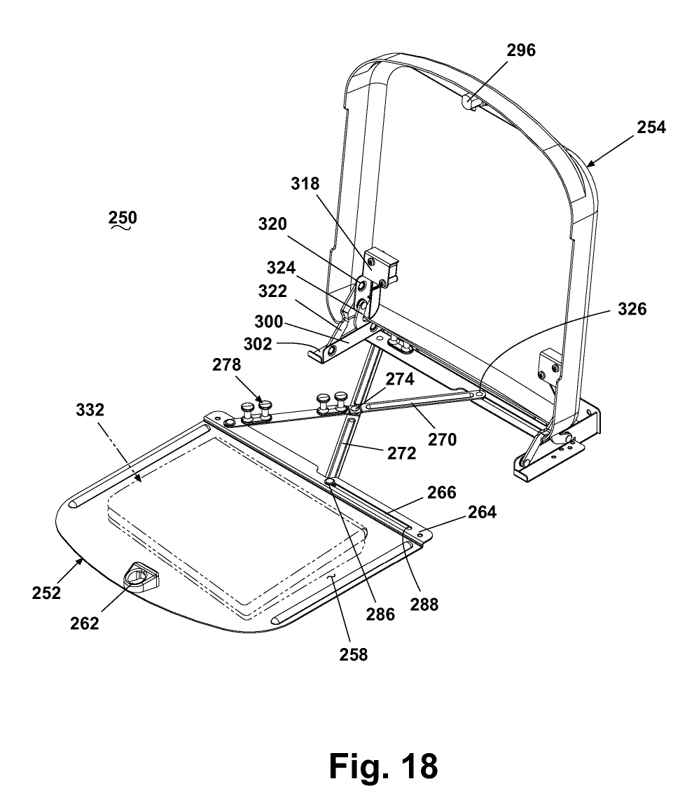

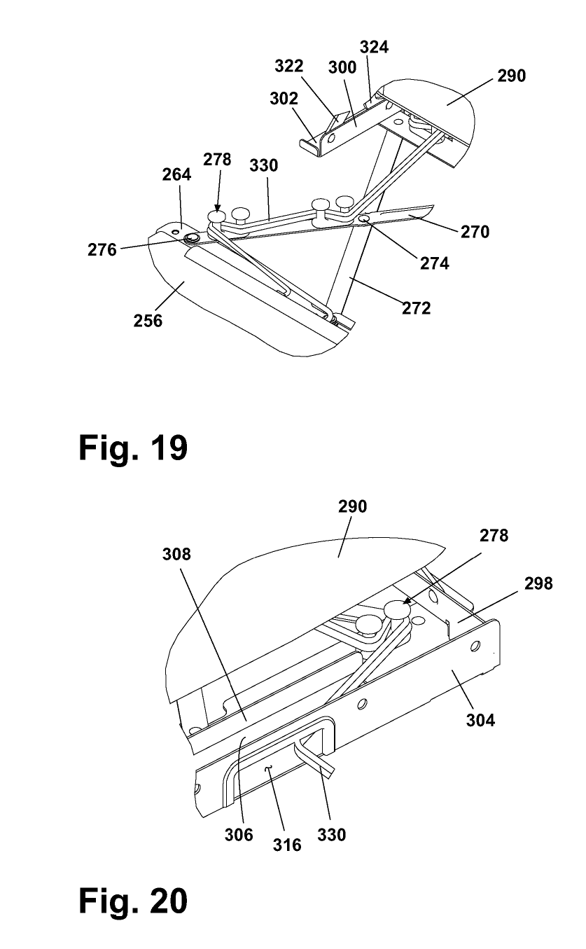

The laptop security device 250 is provided with a wire management system comprising one or more protrusions, such as the cable pin assemblies 278 illustrated in FIGS. 16, 19, and 20, for routing cabling 330 from the laptop computer 330 to power and data sources external to the laptop security device 250. As shown in FIGS. 16, 19, and 20, a cable pin assembly 278 comprises a pair of pins 280 extending orthogonally upwardly from a plate-like base 282. The pins 280 comprise a cylindrical portion terminating coaxially in a circular flat head having a somewhat larger diameter than the cylindrical portion. FIGS. 16 illustrates a laptop security device 250 having three pin assemblies 278, two of which are attached to the upper linkage arm 270, and the third of which is attached to the scissors flange 310. The pin assemblies 278 are attached to the upper linkage arm 270 and the scissors flange 310 through fasteners 284, such as rivets, screws, or bolts. As shown in FIGS. 19 and 20, cabling 330 extending from the laptop computer 330 can be wrapped around and through the pin assemblies 278 to extend along the extender 268 and into the cable compartment 294, to exit through the cable opening 316. The pin assemblies 278 enable the cable 330 to extend between the laptop computer 332 and the cable compartment 294 without impeding the extension and retraction of the pan assembly 252 relative to the cable compartment 294.

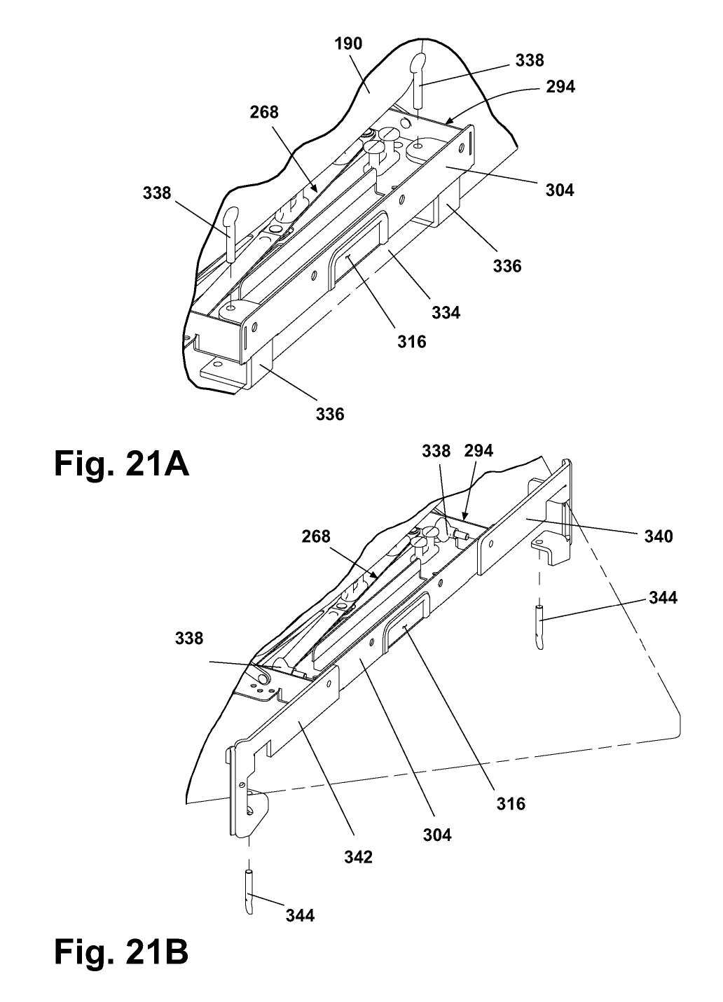

The laptop security device 250 can be secured to a work area 334 by a suitable clamp assembly as illustrated in FIGS. 21A and B. FIG. 21A illustrates a pair of generally C-shaped clamp pieces 336 in operable register with the work area 334 and attached to the bottom wall 306 by thumb screws 338. FIG. 21B illustrates a pair of corner clamp pieces 340, 342 in operable register with the work area 334 and attached to the back wall 304 by thumb screws 338. Threaded fasteners 334, such as wood screws, are used to fasten the corner clamp pieces 340, 342 to the underside of the work area 334. With the cover 190 in the closed and locked position, the thumb screws 338 will be secured within the cable compartment 294, preventing their removal and removal of the security device 250 from the work area 334. The security device can also be secured to the work area 334 by attaching the cable compartment 294 to the workspace surface by threaded fasteners, such as screws, inserted through suitable apertures in the bottom wall 306. With the cable compartment 294 secured to the workspace surface, the pan assembly 252 can be extended away from the cable compartment 294 to bring the laptop computer 332 toward a laptop computer user. The strike 262 is adapted to not only operably mate with the lock 296 to secure the cover 290 to the pan assembly 252, but to serve as a pull.

The novel laptop computer security device described herein provides a secure and easy to use closure device for securing a laptop computer to a workstation thereby minimizing the risk of theft. Securing and preparing the laptop for use takes no more time than it does to open and close the computer. The use of a conventional slam lock ensures that the security device will be locked whenever the cover is moved to the closed position. No additional locking activity must be performed in order to lock the device. Unlocking the cover is simply a matter of inserting and using a key. The embodiments of the security device described herein have been illustrated as accommodating a laptop computer. However, the security device can be utilized for securing other workplace items such as a calculator, an adding machine, a communication device such as a radio, a telephone, and the like. Furthermore, the security device can be adapted to accommodate an independent laptop computer, a laptop computer connected to a network by a contemporary wireless system, or a laptop computer connected to a network through a conventional docking station. In the last example, both the docking station and the laptop computer are supported on the pan for movement with the pan, or within the secured chamber, thereby eliminating the need to reconnect several cables to the computer each time the laptop computer is removed from and replaced in the workplace area.

Use of the laptop security device described herein would be apparent to users of laptop equipment and will only be described briefly here. The use of any of the embodiments of the security device described herein is similar, and the use of each embodiment need not be described individually even though the steps for mounting the laptop security device to a work area may be different.

During use of a laptop, the user will have the cover pivoted to an upward, use position exposing the laptop within the security device. When a user needs to leave the work area where the laptop is located, the cover is simply pivoted downwardly until the lock engages with the strike and securely locks the security device with the laptop inside. The user, of course, would preferably take the key for the lock along, and can return to the work area, insert the key into the lock, and re-open the cover to continue work on the laptop. The security device has an additional benefit in that, when closing the cover of the security device, the security device cover will contact the laptop cover to close the laptop cover in one motion as the security device cover is closed.

The user is not required to move the computer or disconnect any cables to secure the laptop within the security device described herein. Whether the user leaves the computer for a relatively short period of time, or during an extended period of time away from the office, the computer remains secured to the workstation, protected against theft. Adequate space can be provided between the enclosure and the laptop for compact disk drives, floppy disk drives, and other devices to open. The apertures and access slots provide adequate room for routing of wires and cables on both sides and the back of the enclosure. The cover can be closed and secured without disturbing wires that exit to a mouse or other external device, further simplifying the securing of the laptop computer to the workstation. The unit can also be attached to any desktop without creating any visible damage to the desktop. The computer security device also incorporates a forearm pad to improve comfort and reduce the incidence of repetitive motion injury when users rest their arms on the work area. The laptop computer security device can also be attached to an inside corner of two adjoining work areas to create a comfortable 45° corner workstation.

The third embodiment of the laptop security device 250 is particularly advantageous because the device 250 can be mounted to the rear of the workspace surface, thereby freeing up the front of the workspace surface for other activities not requiring the laptop computer 332. When needed, the laptop computer 332 can be readily brought forward toward the user. The hinge assembly 292 enables the device 250 to be mounted against the rear of the workspace surface without interfering with the operation of the cover 290, and provides for locked covering of both the laptop computer 332 and the cable compartment 294.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A security device for attachment to a work area for securing an item therein comprising:
a base configured to be securely mounted to the work area;
a cover mounted to the base to define a secure chamber in cooperation with at least one of the base and the work area, wherein the cover is mounted for movement with respect to at least one of the base and the work area between an open position for providing access to the secure chamber and a closed position for preventing access to the secure chamber; and
a lock cooperating with the cover and at least one of the base and the work area for selectively locking the cover in the closed position, thereby preventing access to the secure chamber;
whereby a computing device can be placed within the secure chamber when the cover is in the open position, and the computing device can be stored within the secure chamber when the cover is moved to the closed position and locked.

2. The security device according to claim 1, wherein the work area is a work surface.

3. The security device according to claim 1, wherein the work area is a table.

4. The security device according to claim 1, and further comprising a pan mounted to the base whereby the pan defines a bottom surface of the secure chamber.

5. The security device according to claim 4, wherein the pan is fixedly attached to the base.

6. The security device according to claim 4, wherein the pan is mounted to the base for movement between a retracted position adjacent the base and an extended position away from the base.

7. The security device according to claim 6, wherein the extended position provides a convenient working position for a computing device sitting thereon.

8. The security device according to claim 6, and further comprising a linkage mechanism mounted between the base and the pan for movement between a collapsed position and an uncollapsed position wherein, when the linkage mechanism is positioned in the collapsed position, the pan is located in the retracted position, and when the linkage mechanism is positioned in the uncollapsed position, the pan is located in the extended position.

9. The security device according to claim 8, wherein the linkage mechanism comprises a pair of interconnected linkage arms forming a scissors-type mechanism.

10. The security device according to claim 4, wherein the base further comprises a recess for routing wires from the pan to the exterior of the base.

11. The security device according to claim 4, and further comprising a wire management system for routing wires between a computing device positioned on the pan and the base.

12. The security device according to claim 11, wherein the wire management system comprises a series of spaced protrusions on the link mechanism.

13. The security device according to claim 1, wherein a portion of the lock is located on the pan.

14. The security device according to claim 13, wherein the portion of the lock located on the pan can be used as a handle to move the pan between the retracted and the extended positions.

15. The security device according to claim 1, wherein a portion of the lock is located on the work area.

16. The security device according to claim 1, wherein the base further comprises a recess for routing wires from the secure chamber to the exterior of the base.

17. The security device according to claim 1, wherein a portion of the lock is located on the cover and a portion of the lock is located on the base.

18. The security device according to claim 1, wherein a portion of the lock is located on the cover and a portion of the lock is located on the work area.

19. The security device according to claim 1, wherein the base is mounted to an upper surface of the work area.

20. The security device according to claim 1, wherein the base is mounted to an underside of the work area.

21. The security device according to claim 1, wherein the base is mounted to an outer surface of the work area.

22. The security device according to claim 1, wherein the base is mounted to the work area by a secure bracket.

23. The security device according to claim 22, wherein the secure bracket can be detached from the work area when the cover is unlocked, but the secure bracket is prevented from detachment when the cover is locked.

24. The security device according to claim 22, wherein the secure bracket cannot be accessed when the cover is locked.

25. The security device according to claim 1, and further comprising a hand rest adapted to be mounted to at least one of the base and the work area.

26. The security device according to claim 1, wherein the cover is mounted to the base by a hinge assembly.

27. The security device according to claim 26, wherein the hinge assembly is configured to maintain the cover in the open position and avoid inadvertent closings thereof.

28. The security device according to claim 26, wherein the hinge assembly laterally moves a rear wall of the cover forwardly during movement of the cover from the closed position to the open position.

29. The security device according to claim 28, wherein the forward movement of the rear wall of the cover exposes the recess at the rear portion of the base for access to wires contained therein.

30. The security device according to claim 28, wherein the forward movement of the rear wall of the cover prevents the rear wall of the cover from extending rearwardly beyond a rear wall of the base, allowing the rear wall of the base to be flush-mounted against a vertical surface.

31. The security device according to claim 1, wherein the base includes a recess at a rear portion thereof for routing wires from within the secure chamber to the exterior of the security device.

32. The security device according to claim 1, wherein the item is a computing device.

33. The security device according to claim 32, wherein the computing device is a laptop computer.

34. The security device according to claim 33, wherein, when the laptop computer is placed in the secure chamber, the movement of the cover from the open position to the closed portion can close the laptop.

35. A security device for attachment to a horizontal work surface for securing a computing device therein comprising:
a base configured to be securely mounted to the work surface;
a cover mounted to the base to define a secure chamber in cooperation with at least one of the base and the work surface, wherein the cover is mounted for movement with respect to the base between an open position for providing access to the secure chamber and a closed position for preventing access to the secure chamber; and a lock cooperating with the cover and at least one of the base and the work surface for selectively locking the cover in the closed position, thereby preventing access to the secure chamber;
whereby a computing device can be placed within the secure chamber when the cover is in the open position, and the computing device can be stored within the secure chamber when the cover is moved to the closed position and locked.

36. The security device according to claim 35, wherein the work surface is a desk.

37. The security device according to claim 35, wherein the work surface is a table.

38. The security device according to claim 35, and further comprising a pan mounted to the base, whereby the pan defines a bottom surface of the secure chamber.

39. The security device according to claim 38, wherein the pan is fixedly attached to the base.

40. The security device according to claim 38, wherein the pan is mounted to the base for movement between a retracted position adjacent the base and an extended position away from the base.

41. The security device according to claim 40, wherein the extended position provides a convenient working position for a computing device sitting thereon.

42. The security device according to claim 40, and further comprising a linkage mechanism mounted between the base and the pan for movement between a collapsed position and an uncollapsed position wherein, when the linkage mechanism is positioned in the collapsed position, the pan is located in the retracted position, and when the linkage mechanism is positioned in the uncollapsed position, the pan is located in the extended position.

43. The security device according to claim 42, wherein the linkage mechanism comprises a pair of interconnected linkage arms forming a scissors-type mechanism.

44. The security device according to claim 38, wherein the base further comprises a recess for routing wires from the pan to the exterior of the base.

45. The security device according to claim 38, and further comprising a wire management system for routing wires between a computing device positioned on the pan and the base.

46. The security device according to claim 45, wherein the wire management system comprises a series of spaced protrusions on the link mechanism.

47. The security device according to claim 35, wherein a portion of the lock is located on the pan.

48. The security device according to claim 47, wherein the portion of the lock located on the pan can be used as a handle to move the pan between the retracted and the extended positions.

49. The security device according to claim 35, wherein a portion of the lock is located on the work area.

50. The security device according to claim 35, wherein the base further comprises a recess for routing wires from the secure chamber to the exterior of the base.

51. The security device according to claim 35, wherein a portion of the lock is located on the cover and a portion of the lock is located on the base.

52. The security device according to claim 35, wherein a portion of the lock is located on the cover and a portion of the lock is located on the work area.

53. The security device according to claim 35, wherein the base is mounted to an upper surface of the work area.

54. The security device according to claim 35, wherein the base is mounted to an underside of the work area.

55. The security device according to claim 35, wherein the base is mounted to an outer surface of the work area.

56. The security device according to claim 35, wherein the base is mounted to the work area by a secure bracket.

57. The security device according to claim 56, wherein the secure bracket can be detached from the work area when the cover is unlocked, but the secure bracket is prevented from detachment when the cover is locked.

58. The security device according to claim 56, wherein the secure bracket cannot be accessed when the cover is locked.

59. The security device according to claim 35, and further comprising a hand rest adapted to be mounted to at least one of the base and the work area.

60. The security device according to claim 35, wherein the cover is mounted to the base by a hinge assembly.

61. The security device according to claim 60, wherein the hinge assembly is configured to maintain the cover in the open position and avoid inadvertent closings thereof.

62. The security device according to claim 60, wherein the hinge assembly laterally moves a rear wall of the cover forwardly during movement of the cover from the closed position to the open position.

63. The security device according to claim 62, wherein the forward movement of the rear wall of the cover exposes the recess at the rear portion of the base for access to wires contained therein.

64. The security device according to claim 62, wherein the forward movement of the rear wall of the cover prevents the rear wall of the cover from extending rearwardly beyond a rear wall of the base, allowing the rear wall of the base to be flush-mounted against a vertical surface.

65. The security device according to claim 35, wherein the base includes a recess at a rear portion thereof for routing wires from within the secure chamber to the exterior of the security device.

66. The security device according to claim 35, wherein the item is a computing device.

67. The security device according to claim 66, wherein the computing device is a laptop computer.

68. The security device according to claim 67, wherein, when the laptop computer is placed in the secure chamber, the movement of the cover from the open position to the closed portion can close the laptop.
